(19) United States
(12) Patent Application Publication
(10) Pub. No.: US 2014/0140674 A1
(43) Pub. Date: May 22, 2014

(54) WIRELESS TRANSMISSION OF MEDIA TO AN AUDIO/VISUAL OUTPUT DEVICE

(71) Applicant: Cambridge Executive Limited, Cambridge (GB)

(72) Inventors: Rafik JALLAD, Cambridge (GB); Petar MINEV, Cambridge (GB)

(73) Assignee: CAMBRIDGE EXECUTIVE LIMITED, Cambridge (GB)

(21) Appl. No.: 14/081,122

(22) Filed: Nov. 15, 2013

(30) Foreign Application Priority Data
Nov. 21, 2012 (GB) 1220943.3
Oct. 23, 2013 (GB) 1318766.1

(51) Int. Cl. H04N 5/93

(52) U.S. Cl. CPC H04N 5/93
USPC 386/200

(57) ABSTRACT

A media player device, such as a PC, portable audio/MP3 player or such like, plays music through a home audio system (stereo system). This can be provided through a wireless link in which the system comprises a transceiver for establishing a short range wireless connection with the media player device, and an output which allows the device to be connected, to an audio/visual output device, e.g., a speaker/screen. A media receiver can maintain two simultaneous short range wireless radio connections with two remote media players and whilst maintaining said connections and whilst receiving a first audio visual signal from one of the two media players, receive a second audio/visual signal from the other of the two media players and route that second audio/visual signal to the audio/visual output device in preference to the first audio/visual signal.

### BACKGROUND

The present invention relates to a system for the transmission of media tracks to an audio and/or visual output device.

It is commonly wished to play music from a media device such as a PC, portable audio/MP3 player or such like through a home audio system (stereo system).

As an alternative to providing a wired link, certain stereo systems include a short range wireless radio transceiver which enables them to receive an audio stream wireles sly from a like adapted media player. Bluetooth® is a commonly used standard in such systems.

Retro-fit audio receivers exist which enable stereos without a wireless receiver to wireles sly receive music from a media player. The retro fitted devices comprise a transceiver for establishing a short range wireless connection with the media player, and an output which allows the device to be connected, usually via an audio cable, to the auxiliary input of the stereo.

### BRIEF SUMMARY

The present invention arose from the inventors' realization that it would be beneficial to allow two media players to stream media to a single audio receiver.

According to a first aspect of the invention there is provided a media receiver for connection to an audio/visual output device to enable media from a remote media player to be played, via a wireless connection between the media receiver and the media player, by the audio/visual output device; the media receiver comprising:

means for maintaining two simultaneous short range wireless radio connections with a respective first and second remote media players in order to receive audio/visual signal from either media player;

an output through which the audio/visual signal received in (i) is sent to the audio/visual output device; and

means for responding to a further audio/visual signal from one of the first or second media players whilst the media receiver is already receiving a first audio/visual signal from the other of the first or second media players, and for sending the further audio/visual signal in preference to the first audio/visual signal, or in termination of the first audio/visual signal, to the output, and whilst maintaining the two simultaneous short range wireless radio connections with both first and second media players.

The invention thereby provides a consistent and reliable means of switching between audio streams from two media devices.

Although the invention was conceived in order to transfer audio, it may also/in addition be used for the transfer of media type such as images and videos.

The audio/visual output device may comprise, for example, a screen for displaying pictures or videos and/or a loud speaker. The loud speaker may be integrated in a device with the screen, be a lone unit or form part of an audio system which may comprise an amplifier and/or other means for controlling/manipulating the media signal.

The media player(s) may be a dedicated device such as an MP3 player, or alternatively provided as a function of a computer (e.g. a tablet PC) or smartphone. Although less likely, the media player may be a CD, a cassette player, or take some other form.

The media receiver may be a separate device or could be integrated within the housing of the audio/visual output device.

It is preferred that the media receiver is responsive to receipt of the further audio/visual signal to transmit an instruction via the wireless connection to the media player transmitting the first audio/visual track to cause the media player to stop transmitting the first audio/visual signal. Preferably the instruction may be used to additionally cause the media player to stop or pause reading an audio/visual track used to generate the audio signal.

The wireless radio connections are preferably established using the Bluetooth standard.

According to a second aspect of the invention there is provided a system for the wireless transmission of a media track to an audio/visual output device to play the media track; the system comprising:

a first media player and a second media player, each holding or controlling a number of media tracks; each of the first and second media players having a transceiver for transmitting a media track and/or media track identifier over a short range wireless connection to a media receiver;

the media receiver having a transceiver for receiving said media track and/or media track identifier via the short range wireless radio connection, the media receiver also having an output for connection to the audio/visual output device;

means for generating a playlist and to allow a user of either first or second media player to populate the playlist with an entry comprising a track identifier of a media track held on the user's respective media player and selected by the user to be played by the audio/visual output device; and

means, using the playlist, to regulate the transmission of said media tracks to the media receiver.

Through use of the second invention, it is possible for multiple users, each having their own media player, to select media, e.g. songs, videos, pictures, to be played by the output device and to see the media that has been selected by others before it is played.

By using a playlist that is accessible to both media players, it is not necessary for a copy of each selected media track to be held by both first and second devices.

In a preferred embodiment, a copy of the playlist is held by both the first and second media players. When a user of either media player populates the playlist with an entry, the track identifier can be transmitted to the other media player via the media receiver. In this way, the copies of the playlist held on the media players and media receiver can be synchronized.

In a preferred embodiment, the media tracks are transmitted from the first and second media players, over the short range wireless connection, to the media receiver which also holds a copy of the playlist. These transmissions may occur in response to instructions received from the media receiver, which preferably also holds a copy of the playlist.

The media track may be held on a memory of the media player or remotely, for example, on a server accessible to the media player via a network/the internet. The remotely stored media track maybe streamed directly to the audio receiver, e.g. via the internet.

The store in memory of each playlist entry preferably comprises or is associated with a media player identifier which identifies the media player used to create the entry. This information can be used, for example, by the media receiver in order to send instructions to the relevant media player to transmit the media track in question to the media receiver.

### BRIEF DESCRIPTION OF THE DRAWINGS

The invention will now be described by way of example with reference to the following figures in which:

FIG. 1 is schematic of a system comprising an audio receiver to enable music on two smartphones to be played by a speaker remote to the smartphones via a wireless radio connection;

FIG. 2 is a flow chart illustrating the processes taken by the audio receiver when receiving a signal comprising both a A2DP message and a AVRCP/IAP message; and

FIG. 3 illustrates schematically an alternative system comprising an audio receiver to allow songs on a number of personal music players to be played by a speaker remote to the personal music players.

### DETAILED DESCRIPTION

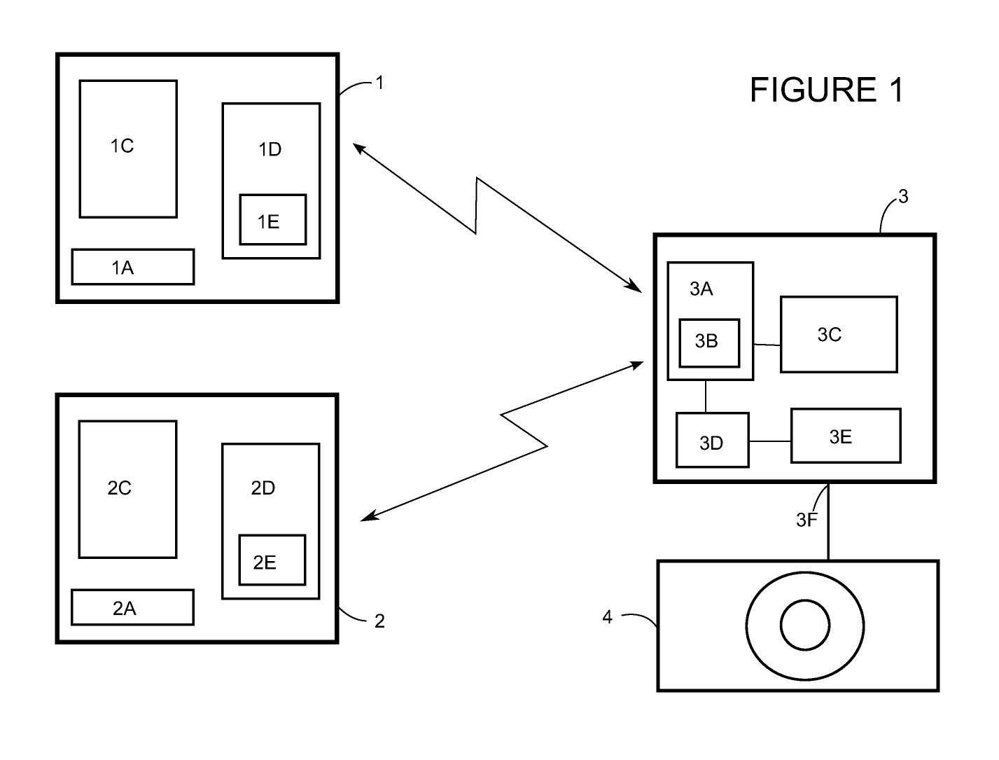

FIG. 1 illustrates two smartphones 1, 2, an audio receiver 3, and a loud speaker 4.

Each smartphone 1, 2 comprises a non-volatile memory 1A, 2A, for example, in the form of a flash memory; means to run a media player application 1C, 2C; and a Bluetooth unit 1D, 2D which includes a short range radio transceiver 1E, 2E.

The audio receiver 3 has a Bluetooth unit 3A comprising a short range radio transceiver 3B, a controller 3C; a digital to analog converter 3D, an amplifier 3E, and an output 3F in the form of electrical connector.

The loudspeaker 4 may be incorporated as part of a larger sound system, e.g. a home audio system having multiple speakers, its own amplifier and/or other electronics to manipulate audio signals.

When switched on, the audio receiver 3 adopts a discoverable mode in which it transmits identification information upon demand. Using established Bluetooth protocols, the audio receiver can establish a connection to Bluetooth unit 1D of phone 1 following a specific request from the user of the phone to connect with the audio receiver 3. The forming of a connection will also typically include, at least for the first time, a pairing procedure involving the sharing of a key to enable an encrypted connection. The pairing procedure uses standard Bluetooth protocols which are well known in the art.

A similar process is used to establish a wireless connection between the audio receiver 3 and Bluetooth unit 2D of phone 2. Bluetooth protocol provides a function to allow the audio receiver 3 to maintain simultaneous connections with the Bluetooth units 1D, 2D of both phones 1 and 2.

When a user of phone 1 operates the media player application 1C to play an audio file held in the memory 1A, the media player generates an audio signal representative of the audio file. With a connection between audio receiver 3 and phone 1 established, the audio signal is fed to the Bluetooth unit 1D for transmission via transceiver 1E to unit 3A in receiver. The received audio signal is processed if required, e.g. decoded, before being forwarded by unit 3A to the digital to analog converter 3D. The resulting analog signal is amplified by amplifier 3E and fed to output 3F.

An equivalent process occurs when the user of phone 2 uses the media player application 2C to play an audio file from memory 2A.

If Bluetooth is used as the protocol for wireless communication by the audio receiver, the audio file is typically transmitted using Advanced Audio Distribution Profile (A2DP), a known specification of the Bluetooth standard for transmitting/receiving audio files.

In the instance that a first audio signal is being transmitted from phone 1 to the audio receiver 3, and that, while the first audio signal is being transmitted, a second audio signal is then transmitted from phone 2 to the audio receiver 3, the controller 3C, having identified that two audio signals deriving from different remote devices are being received:

stops the first audio signal received from phone 1 being forwarded to the digital to analog converter 3D; and instead forwards the second audio signal from phone 2 to the digital to analog converter 3D, and thence the output 3F.

The controller 3C also causes an instruction to be sent via transmitter 3B to the Bluetooth unit 1A which causes the Bluetooth unit 1D to stop transmitting an audio signal. The instruction is preferably in the form of a ‘pause’ or ‘stop’ command, a function available through the Audio/Video Remote Control Profile (AVRCP), a further specification of the Bluetooth Standard that causes the media player which receives the command to pause or stop reading the track. Additionally, the controller 3C is preferably adapted to respond to other protocols, including the proprietary IAP used by devices manufactured by Apple® instead of AVRCP. This allows the audio receiver to operate with media players which use this protocol.

In the instance that the audio receiver is receiving an audio signal from the second phone 2 and subsequently receives an audio signal from phone 1, the controller 3C will forward the audio signal from first phone 1 in preference to signal from second phone 2 and send a pause/stop instruction to the second phone 2.

The controller 3C may identify the two audio signals based on either the receipt of messages sent through A2DP or AVRCP. Response based on the latter can lead to improved response times. This is particularly so where a device tries to re-start transmitting an audio signal shortly after receiving a pause/stop command from the audio receiver as it can take several (often 10-20) seconds for the device to disconnect the A2DP connection following receipt of said command. A play action made by the user within this time would not cause an A2DP message to be sent by the device and therefore the audio receiver would be unresponsive.

Where the device is configured with newer versions of AVRCP, or IAP, the play action by the user prompts an AVRCP or IAP message to be sent to the audio device. However, as the play action by the user does not prompt some older devices to send AVRCP messages, it is advantageous that the controller 3C can respond to both to ensure that the audio receiver is compatible with as many devices as possible.

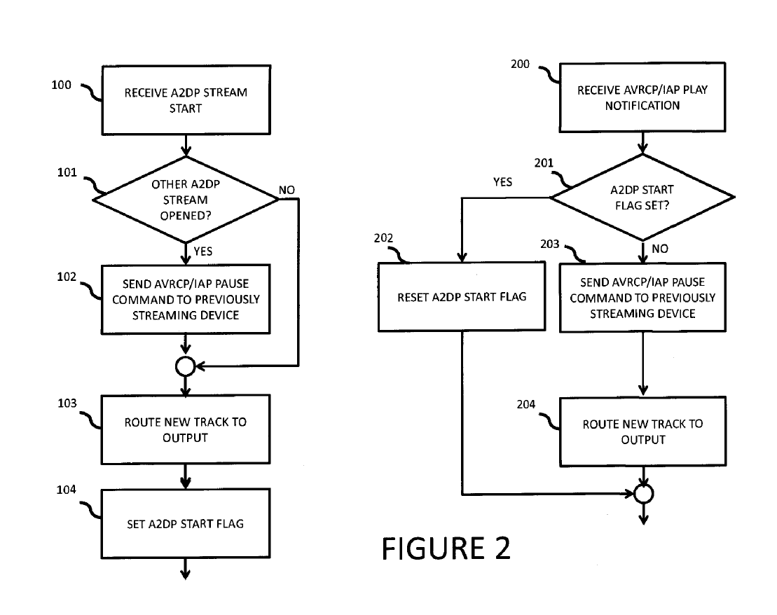

Certain devices may send an audio signal which comprise both an A2DP message and an AVRCP(IAP) message. The manner in which the audio receiver responds to an audio signal comprising both an A2DP message and an AVRCP(IAP) message from a second device is illustrated in FIG. 2.

In accordance with Bluetooth protocol, the A2DP message is received first 100. The audio receiver in response checks whether it is already receiving an audio signal from a first device 101. If it isn't, it routes the audio stream from the second device to the output 103. If an audio signal is being received from the first device, the audio receiver sends an AVRCP(IAP) pause message to said first device 102, and then routes the new audio (A2DP) signal from the second device to the output 103. The audio receiver also sets a flag 104.

Upon receipt of the AVRCP message 200, the audio receiver checks 201 whether the flag 104 is set. If it is set, the audio player resets the flag 202.

If the flag is not set, it sends an AVRCP(IAP) pause message to the first device 203, and routes the new audio signal from the second device to the output 204.

In this way, the audio receiver is able to switch the audio signal when receiving either an A2DP message or an AVRCP message, but will not be responsive to both the A2DP message and AVRCP message if an audio signal comprises both. This is important as otherwise the audio receiver would route the new audio signal in response to receiving the A2DP message and then erroneously pause the newly routed audio signal in response to receiving the AVRCP message.

For simplicity, the above examples describe an audio receiver connected to two phones; however, the audio receiver can establish simultaneous connections with more than two phones (or other media devices) in order to receive and forward audio/visual signals from any one of them. The controller 3C acts in the same way irrespective of the number of connected devices, forwarding the later received signal in preference to the signal being currently forwarded.

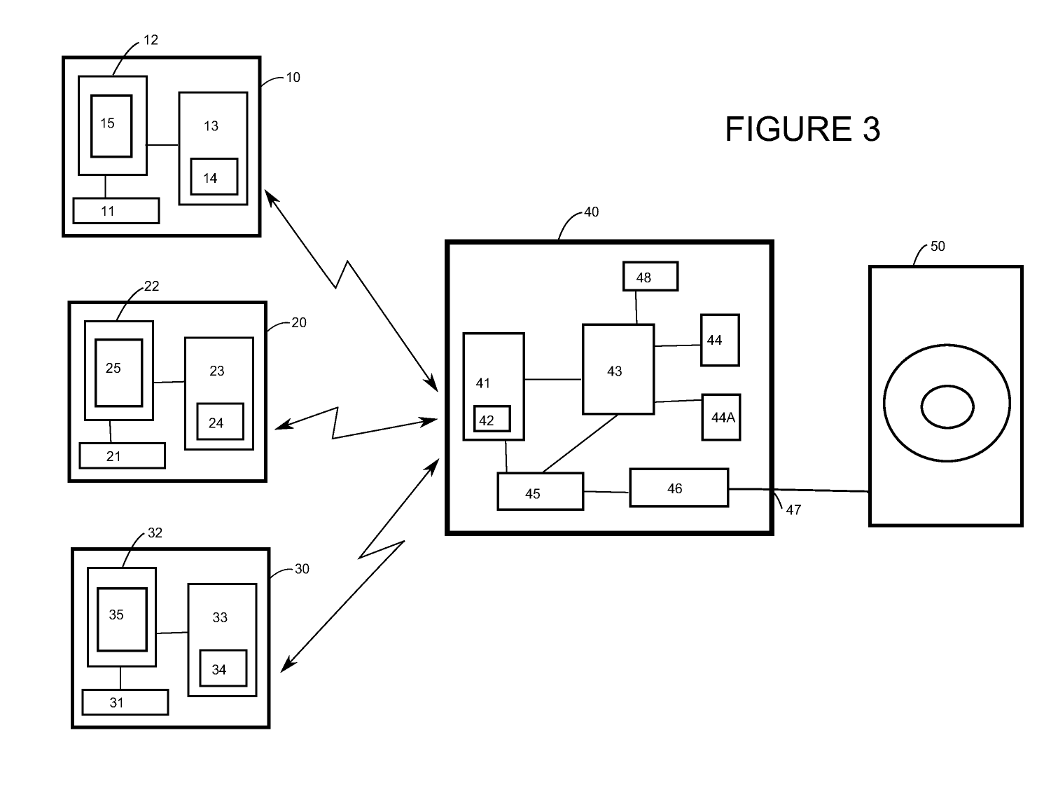

FIG. 3 illustrates schematically an alternative system to enable music on a personal music player to be transmitted wirelessly to a speaker remote to the personal music player. There is shown a first media player device 10, a second media player device 20 a third media player device 30; an audio receiver 40 and a speaker 50.

Each of the first, second and third media devices 10, 20, 30 comprise a memory 11, 21, 31 for storing audio tracks, a media player 12, 22, 32 which is an application run by processing circuitry of the media devices 10, 20, 30 for playing audio tracks from memory 11, 21, 31; and Bluetooth unit 13, 23, 33 comprising a short range radio transceiver 14, 24, 34.

The audio receiver 40 comprises a Bluetooth unit 41 which may take the form of a Bluetooth chip and comprises a short range radio transceiver 42; the audio receiver also comprises a controller 43, a track register 44, a device register 44A, a digital to analog converter 45, amplifier 46 and output 47.

The audio receiver 40 is able, using Bluetooth protocol, to establish and maintain simultaneous wireless connections with each of the Bluetooth units 13, 23, 33 of media player devices 10, 20, 30.

The media player 12 generates a playlist 15. The user of the media device, 10 using the media player 12 can add entries to the playlist 15 by selecting audio track held in memory 11 for transmission via the wireless connection with the audio player to speaker 50.

Upon the addition of an entry to the playlist 15, the media player 12 sends an identifier of the selected audio track to the controller 43 over the short range wireless connection. The identifier may comprise one or more, though preferably all of: (i) the artist, (ii) track name/title, (ii) track length. The controller 43 uses the received track identifier to create an entry in track register 44 corresponding to the entry held in playlist 15. The entry made in the track register 44 also holds the identifier of device 10. The identifier of the device may have been sent by device 10 with the identifier of the selected audio track to the controller 43. Alternatively the controller 43 may derive the device identity from the identity of the wireless connection from which the message originated.

When the second device 20 running application 22 forms a wireless connection with audio receiver 30, the application 22 first sends a request to controller 43 for details of entries held in track register 44. The controller 43 responds by sending details of the entries held in track register 44. It also adds an entry in device register 44A identifying the newly connected device 20. Application 22 uses the received track entries to populate its own playlist 25 generated by the application 22 upon start up. Following this exchange, the user of device 20 can see details and the order of the audio tracks held in the first device's playlist 15. Once populated, the user of second device 20 can also add their own audio tracks to playlist 25.

When a track is added to playlist 25 by the user of second device 20, media player 22 sends a message to the controller 43 comprising an identifier of the audio track in the manner as before described. The controller 43 uses the received identifier to create an entry in register 44 with an associated identifier of device 20. The controller 43 also sends the track identifier received from device 20 to each of the devices identified in registry 44A (e.g. devices 10 and 30). The media players 12, 22, 32 of the respective devices, use the received identifier to create a corresponding entry in their own playlist. In this way the playlists 15, 25, 35 are synchronized.

The controller 43 selects entries from the track register 44 according to a pre-determined routine. The routine may be determined by the user of the first device 10 to form a connection with the audio receiver 40. The routine may be, for example, to select each entry in turn or in a pseudo-random fashion.

Upon selection of an entry, the controller 43 sends an instruction to the media player identified from the device identifier associated with the entry, to transmit the audio file associated with the track identifier of that entry.

Upon receiving the instruction, the selected audio player 10, 20, 30 reads the corresponding audio file from memory 11, 21, 31. The resulting audio signal is transmitted via transceiver 14, 24, 34 over the wireless radio connection to the Bluetooth chip 41. This signal is forwarded to the DAC 45 and amplifier 46, and then to output 47 for playing by stereo 50.

The controller 43 transmits a message to the other connected devices with the track identifier of the entry that has been selected for playing. This allows the other, non reading, media players to update their respective playlists to show which entry is currently being played.

Following transmission of a track to the audio receiver 40, the controller 43 looks up in register 44 the next entry and transmits an instruction to the media player identified with the entry to start transmitting the song associated with that entry. This process is repeated in order to play all of the tracks mentioned in the playlist.

In order to identify when a song is to finish, the controller 43 uses a timer 48 and track length information received with or as part of the track identifier from the media player holding the track. Alternatively, the transmitting device may be arranged to send a message to the controller once the track has been successfully transmitted.

In a variation, the controller 43 may request transmission of the next song in the track register 44 before the present song has finished streaming. The next song can then be buffered in a memory (not shown) of the audio receiver 40, in order to be played as soon as the current song has finished. Alternatively, this method may be used to mix the two songs together. The audio receiver 3 may be provided with additional circuitry and/or programming functions to do this.

To ensure that the entries in each playlist 15, 25, 35 and the register 44 are in the same order, each entry added to the register 44 is provided with an index reference. The index reference is forwarded to each of connected devices 10, 20, 30 with the track identifier and used by the media players 12, 22, 32 to order the entry with respect to the other entries in their playlists.

If a user of one of the devices (in this example device 10) removes or reorders track(s) on their respective playlist 15. The media player 12 sends a message to the controller 43 identifying the track(s) in question (e.g. using the track identifier) and nature of the change. The controller 43 updates the register 44, e.g. by removing the track if it is a deletion, or changing the index identifiers of the reordered tracks. The controller 43 then sends notification of the changes to the other devices 20, 30 in order that the update be made on respective playlists 25, 35. The control of administrative functions such as deletion or reordering of tracks may be provided only to selected connected devices.

The controller 43 is programmed to periodically send status messages to each connected devices 10, 20, 30. The status messages may comprise information such as: the identifier of the track which is playing; the length of time that the track has been playing; the time left to play; the identifier of the device which is playing the track etc. The media players 12, 22, 32 may use this information to update their playlist, or provide addition information to the users of the devices.

If media device 10 intentionally disconnects from the audio receiver 40, the media player 15 will notify the controller 43 which removes entries from the register 44 which are associated with that device 10, and inform the other devices of the changes made. It will also remove the entry for the device from register 44A. The same process is used if any other of the devices intentionally disconnect.

The controller 43 will also perform this procedure if it identifies that one of the devices 10, 20, 30 is no longer contactable, e.g. because the device has moved out of range, crashed or similar. Alternatively, the controller 43 may maintain the relevant tracks in the register 44 but skip entries which are associated with the device until the device becomes available again. If the device 10 does not become contactable after a pre-determined period of time, e.g. 5 minutes, the controller 43 may then remove the entries associate with the device 10 from its registry 44 and inform the other devices 20, 30 of the change as before.

If the controller 43 identifies that a lost connection to a device which is in the process of streaming an audio signal, the controller 43 will cause for the next entry in the register 44 that is not associated with that device to be played.

It is envisage that the register 44 and 44A could be held by the memory of the Bluetooth unit 41. The memory of commercial available units is probably not large enough to hold a complete playlist if very long. To overcome this, the controller 43 may periodically send a request to one of the devices to transmit track identifiers relating to index references beyond that held in the register 44. When the register 44 is full, the controller will continue forwarding received track identifiers with index references as before so that the playlists 15, 25, 35 of the devices remain synchronized, but will not make a corresponding entry in register 44.

Although the above embodiment has been described using Bluetooth it is possible that other standards or protocols may be used.

Rather than the audio files being stored on the memories 11, 21, 31 of the devices 10, 20, 30, they may instead by stored remote from the devices e.g. on a server accessed via a network/and or the internet. In one variation, the audio receiver may be provided with means to access the server, and using the track identification (and possible other security information) provided by the device over the wireless connection, connect with the server and receive the track directed from the server.

Although the above embodiment is described using three devices, it is envisaged that the system can be used with any number of devices, limited only by the number of simultaneous connections that can be supported by the wireless protocol used to connect the devices to the audio receiver 40.

The system as illustrated in FIG. 3 may equally be used with media files other than audio tracks such as image files or video files. For example the system could be used, in conjunction with a television as an output device, to select and show music videos or films.

Accordingly, the definition of the term “media receiver” is intended to broadly cover a receiver of one or more types of media files or messages that can be used in conjunction with an output device to output corresponding sensory signals, including, but not limited to, the following sensory signal types: audible signals, visual signals, haptic signals, odoriferous signals, and any combination thereof. Also, the definition of the term “media track” is intended to broadly cover many different types of media data modules, files, messages, and the like, including, but not limited to, audio tracks, audio files, video tracks, video files, image files, and any combination thereof. The audio receiver 3 and the audio receiver 40, in the above discussions, are examples of a media receiver.

It is not essential that the audio receiver comprise a DAC or amplifier as these functions may instead be provided by the stereo system.

Although the present specification may describe components and functions implemented in the embodiments with reference to particular standards and protocols, the disclosure is not limited to such standards and protocols. Each of the standards represent examples of the state of the art. Such standards are from time-to-time superseded by equivalents that may be faster or more efficient, but having essentially the same structures and/or functions.

The illustrations of examples described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense. Additionally, unless otherwise specifically expressed or clearly understood from the context of use, a term as used herein describes the singular or the plural of that term.

The terms “a” or “an”, as used herein, are defined as one or more than one. The term “plurality”, as used herein, is defined as two or more than two. The term “another”, as used herein, is defined as at least a second or more. The terms “including” and “having,” as used herein, are defined as comprising (i.e., open language). The term “coupled,” as used herein, is defined as “connected,” although not necessarily directly, and not necessarily mechanically. “Communicatively coupled” refers to coupling of components such that these components are able to communicate with one another through, for example, wired, wireless or other communications media. The term “communicatively coupled” or “communicatively coupling” includes, but is not limited to, communicating electronic control signals by which one element may direct or control another. The term “configured to” describes hardware, software or a combination of hardware and software that is adapted to, set up, arranged, commanded, altered, modified, built, composed, constructed, designed, or that has any combination of these characteristics to carry out a given function. The term “adapted to” describes hardware, software or a combination of hardware and software that is capable of, able to accommodate, to make, or that is suitable to carry out a given function.

Although specific embodiments have been illustrated and described herein, it should be appreciated that any arrangement calculated to achieve the same purpose may be substituted for the specific embodiments shown. The examples herein are intended to cover any and all adaptations or variations of various embodiments. Combinations of the above embodiments, and other embodiments not specifically described herein, are contemplated herein.

The Abstract is provided with the understanding that it is not intended be used to interpret or limit the scope or meaning of the claims. In addition, in the foregoing Detailed Description, various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

The corresponding structures, materials, acts, and equivalents of all means or step plus function elements in the claims below are intended to include any structure, material, or act for performing the function in combination with other claimed elements as specifically claimed. The description herein has been presented for purposes of illustration and description, but is not intended to be exhaustive or limited to the examples in the form disclosed. Many modifications and variations will be apparent to those of ordinary skill in the art without departing from the scope of the examples presented or claimed. The disclosed embodiments were chosen and described in order to explain the principles of the embodiments and the practical application, and to enable others of ordinary skill in the art to understand the various embodiments with various modifications as are suited to the particular use contemplated. It is intended that the appended claims below cover any and all such applications, modifications, and variations within the scope of the embodiments.

What is claimed is:

1. A media receiver for connection to an audio/visual output device to enable media from a remote media player to be played, via a wireless connection between the media receiver and the media player, by the audio/visual output device; the media receiver comprising:
i) means for maintaining two simultaneous short range wireless radio connections with a respective first and second remote media player in order to receive audio/visual signal from either media player;
ii) an output through which the audio/visual signal received in (i) is sent to the audio/visual output device; and
iii) means for responding to a further audio/visual signal from one of the first or second media players whilst it is already receiving a first audio/visual signal from the other of the first or second media players, and for sending the further audio/visual signal in preference to the first audio/visual signal, or in termination of the first audio/visual signal, to the output, and whilst maintaining the two simultaneous short range wireless radio connections with both first and second media players.

2. A media receiver according to claim 1 wherein the media receiver is also arranged to transmit an instruction via the wireless connection to the media player transmitting the first audio/visual signal to cause the media player to stop transmitting the first audio/visual signal.

3. A media receiver according to claim 2 wherein the instruction causes the media player to stop or pause reading of an audio/visual track used to generate the audio/visual signal.

4. A media receiver according to claim 3 characterized in that the audio receiver has means responsive to an A2DP message or an AVRCP/IAP message received from the second media player, to send the further audio/visual signal in preference to the first audio/visual signal to the output.

5. A media receiver according to claim 4 comprising a means responsive to the A2DP message in order to send the further audio/visual signal in preference to the first audio/visual signal to the output, and blocking means to stop the media receiver, upon subsequent receipt of the AVRCP/IAP message, from transmitting an instruction via the wireless connection to the second media player to cause the media player to stop transmitting the further audio/visual signal.

6. An application arranged to be run on both a first and second media players of claim 4 in order to generate a playlist on each of the first and second media players and to allow a user of either of first and second media player to populate the playlist of their respective media player with entries comprising a track identifier of a media track held on or controlled by the user's respective media player and selected by the user to be played by the audio/visual output device; the application being adapted for communication with a further application run on a media receiver of claim 4 to enable the entries populated on any one of the first and second media players to be copied, via the media receiver, onto the playlist of the other media player in order to synchronize the playlists of the respective first and second media players.

7. A system for the transmission of a media track to an audio/visual output device to play the media track; the system comprising:
a first media player and a second media player, each holding or controlling a number of media tracks; each of the first and second media players having a transceiver for transmitting a media track and/or media track identifier over a short range wireless connection to a media receiver;
the media receiver having: a transceiver for receiving said media track and/or media track identifier via the short range wireless radio connection, and an output for connection to the audio/visual output device;
means for generating a playlist and to allow a user of either media player to populate the playlist with an entry comprising a track identifier of a media track held on or controlled by the user's respective media player and selected by the user to be played by the audio/visual output device; and
means, using the playlist, to regulate sending of said media tracks to the media receiver.

8. A system according to claim 7 wherein a copy of the playlist is held by both the first and second media players.

9. A system according to claim 8 comprising means to allow a user of either media player to populate the copy of the playlist held on their media player with an entry comprising the track identifier of a media track held or controlled by their respective media player and selected by the user to be played by the audio/visual output device, and wherein the track identifier is transmitted to the other media player via the media receiver.

10. A system according to claim 8 wherein the media receiver also holds a copy of the playlist.

11. A system according to claim 8 wherein the entry comprises a media player identifier which identifies the media player through which the entry to the playlist was added.

12. A system according to claim 7 comprising means, using the playlist, to regulate the transmission of said media tracks from the first and second media players, over the short range wireless connection, to the media receiver.

13. A system according to claim 12 wherein the media receiver selects an entry from the playlist and sends, via the wireless communication link, an instruction to the device identified from the media player identifier, to transmit the media track to the media receiver.

14. A media receiver of claim 7.

15. A media receiver for use in a system for the transmission of a media track to an output device to play the media track; the system comprising:
a first media player and a second media player, each holding or controlling a number of media tracks; each of the first and second media players having a transceiver for transmitting a media track and/or media track identifier over a short range wireless connection to a media receiver; and
the media receiver comprising:
a transceiver for receiving said media track and/or media track identifier via the short range wireless radio connection, and an output for connection to the output device;
means for generating a playlist and to allow a user of either media player to populate the playlist with an entry comprising a track identifier of a media track held on or controlled by the user's respective media player and selected by the user to be played by the output device; and
means, using the playlist, to regulate sending of said media tracks to the media receiver.
